(19) United States
(12) Patent Application Publication
(10) Pub. No.: US 2023/0186307 A1
(43) Pub. Date: Jun. 15, 2023

(54) METHOD FOR ENHANCING TRANSACTION SECURITY

(71) Applicant: International Business Machines Corporation, Armonk, NY (US)

(72) Inventors: Yoonyoung Park, Belmont, MA (US); Issa Sylla, Boston, MA (US); Viatcheslav Gurev, Bedford Hills, NY (US); James R. Kozloski, New Fairfield, CT (US); Uri Kartoun, Cambridge, MA (US)

(21) Appl. No.: 17/549,954

(22) Filed: Dec. 14, 2021

(51) Int. Cl. G06Q 20/40; G06N 3/04

(52) U.S. Cl. CPC G06Q 20/40145; G06N 3/0454

(57) ABSTRACT

A computer-implemented method for transaction authorization is disclosed. The computer-implemented method includes receiving a transaction request from a user to access a resource. The computer-implemented method further includes determining historical biometric data for the user. The computer-implemented method further includes determining current biometric data for the user at a time the transaction request is received. The computer-implemented method further includes determining whether the historical biometric data for the user matches the current biometric data for the user at the time the transaction request is received. The computer-implemented method further includes responsive to determining that the historical biometric data for the user matches the current biometric data for the user at the time the transaction request is received, authorizing the transaction request to access the resource.

### BACKGROUND

The present invention relates generally to the field of transaction security, and more particularly to, transaction security for accessing resources by verifying biometric data.

A transaction involves a request for and an exchange of or access to an asset. For example, a transaction may involve a request for money and the exchange of said requested money after verification of a user’s access credentials. Current automatic teller machine (ATM) or card reader machines typically require a user to enter a personal identification number (PIN) number associated with their debit card in order to authorize a transaction and grant access to resources.

Biometric authentication is a security process that relies on the unique biological characteristics of individuals to verify their identity. Biometric authentication systems compare physical or behavioral traits to stored, confirmed, authentic data associated with an individual. Typically, biometric authentication is used to manage access to physical and digital resources, such as facilities, buildings, rooms, computing devices, and websites.

### SUMMARY

According to one embodiment of the present invention, a computer-implemented method for transaction authorization is disclosed. The computer-implemented method includes receiving a transaction request from a user to access a resource. The computer-implemented method further includes determining historical biometric data for the user. The computer-implemented method further includes determining current biometric data for the user at a time the transaction request is received. The computer-implemented method further includes determining whether the historical biometric data for the user matches the current biometric data for the user at the time the transaction request is received. The computer-implemented method further includes responsive to determining that the historical biometric data for the user matches the current biometric data for the user at the time the transaction request is received, authorizing the transaction request to access the resource.

According to another embodiment of the present invention, a computer program product for transaction authorization is disclosed. The computer program product includes one or more computer readable storage media and program instructions stored on the one or more computer readable storage media. The program instructions include instructions to receive a transaction request from a user to access a resource. The program instructions further include instructions to determine historical biometric data for the user. The program instructions further include instructions to determine current biometric data for the user at a time the transaction request is received. The program instructions further include instructions to determine whether the historical biometric data for the user matches the current biometric data for the user at the time the transaction request is received. The program instructions further include instructions to responsive to determining that the historical biometric data for the user matches the current biometric data for the user at the time the transaction request is received, authorize the transaction request to access the resource.

According to another embodiment of the present invention, a computer system for transaction authorization is disclosed. The computer system includes one or more computer processors, one or more computer readable storage media, and computer program instructions, the computer program instructions being stored on the one or more computer readable storage media for execution by the one or more computer processors. The program instructions include instructions to receive a transaction request from a user to access a resource. The program instructions further include instructions to determine historical biometric data for the user. The program instructions further include instructions to determine current biometric data for the user at a time the transaction request is received. The program instructions further include instructions to determine whether the historical biometric data for the user matches the current biometric data for the user at the time the transaction request is received. The program instructions further include instructions to responsive to determining that the historical biometric data for the user matches the current biometric data for the user at the time the transaction request is received, authorize the transaction request to access the resource.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of a network computing environment for authorizing a transaction based on matching biometric data, generally designated 100, in accordance with at least one embodiment of the present invention.

FIG. 2 is a flow chart diagram depicting operational steps for authorizing a transaction based on biometric data, generally designated 200, in accordance with at least one embodiment of the present invention.

FIG. 3 is a diagram depicting a trained recurrent generative adversarial network (r-GAN) for super-resolution imaging.

FIG. 4 is a block diagram depicting components of a computer, generally designated 400, suitable for executing a secure transaction program 101 in accordance with at least one embodiment of the present invention.

FIG. 5 is a block diagram depicting a cloud computing environment 50 in accordance with at least one embodiment of the present invention.

FIG. 6 is block diagram depicting a set of functional abstraction model layers provided by cloud computing environment 50 depicted in FIG. 5 in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present invention relates generally to the field of transaction security, and more particularly to, transaction security for accessing resources by verifying biometric data.

Current ATM or card reader machines require a user to enter a PIN number associated with his/her debit card in order to authorize a transaction and access resources. Meaning, a person can gain access to a user’s resources, such as a bank account, with just a debit card and knowledge of its linked PIN number. Unfortunately, a person with malicious intent may be able to steal a user’s card and retrieve the PIN to gain access to the user’s resources. Accordingly, embodiments of the present invention recognize the need for an enhanced method of authentication for transactions.

Embodiments of the present invention recognize that authenticating a person’s biometrics at the time of the requested transaction in addition to authenticating the user’s account PIN would enhance security of the person’s account. Embodiments of the present invention utilize one or more sensors at the point of the transaction in order to identify various biometric data associated with the person attempting to make the transaction. For example, if user A is at an ATM attempting to withdraw cash, the present invention determines user A’s height and determines whether user A’s height matches a registered height of an authorized user of the account. If the user’s PIN, in addition to user A’s height at the time of authentication matches the registered height of an individual associated with the account, the transaction is authorized.

Embodiments of the present invention recognize there may be discrepancy issues with sensors used to authenticate biometric data. This may be caused by the user’s varying biometrics, holding an object, such as a purse while the sensor measures, wearing winter vs. summer clothes affecting weight variability, or bias and noise within the sensor. Embodiments of the present invention further recognize there is a probability distribution on the sensor’s measurements and utilize a GAN to increase verification. Embodiments of the present invention recognize that an account holder may want to authorize the use of or access to the account with one or more additional people. For example, a mother may want to authorize her child to use their debit card. Embodiments of the present invention recognize that one authorized user of the card may utilize the card more frequently than another authorized user of the card.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suit-able combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

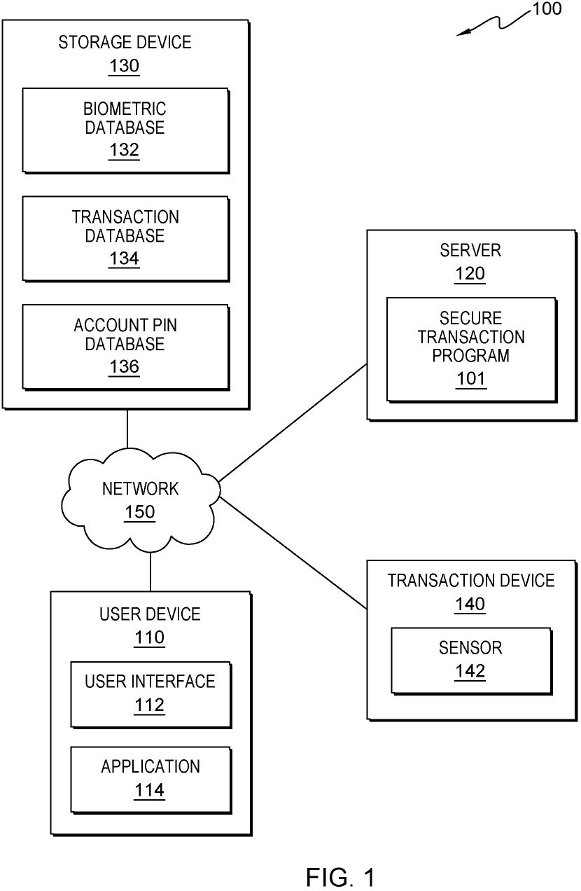

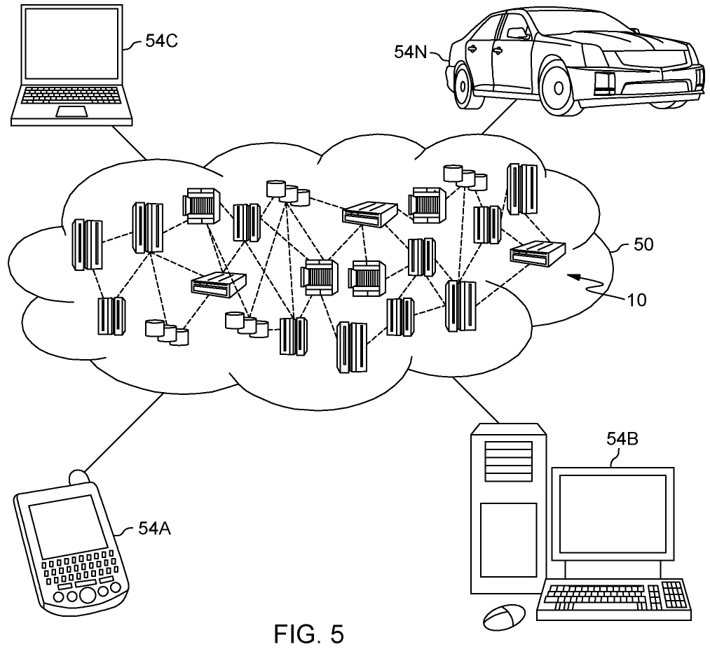

The present invention will now be described in detail with reference to the Figures. FIG. 1 is a functional block diagram of a network computing environment for authorizing a transaction based on matching biometric data, generally designated 100, in accordance with at least one embodiment of the present invention. In an embodiment, network computing environment 100 may be provided by cloud computing environment 50, as depicted and described with reference to FIG. 5, in accordance with at least one embodiment of the present invention. FIG. 1 provides an illustration of only one implementation and does not imply any limitations with regard to the environments in which different embodiments may be implemented. Many modifications to the depicted environment may be made by those skilled in the art without departing from the scope of the present invention as recited by the claims.

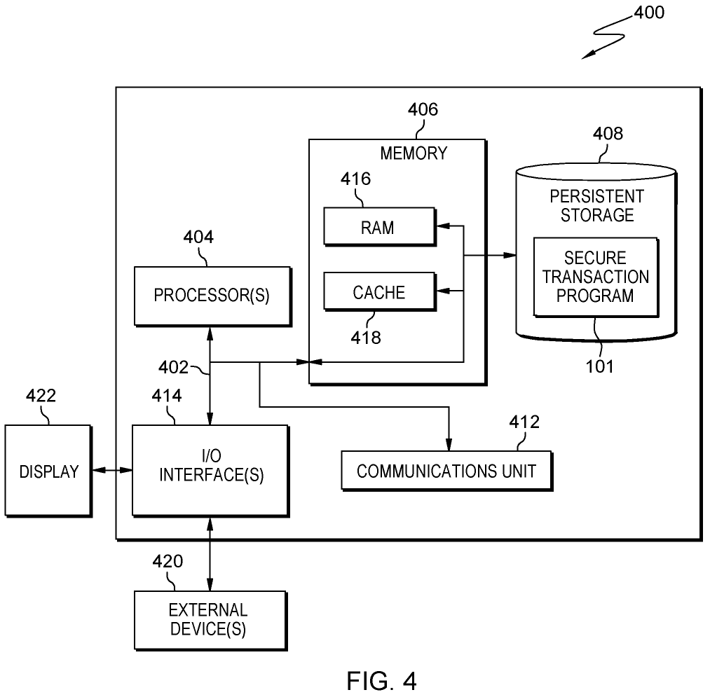

Network computing environment 100 includes user device 110, server 120, storage device 130, and transaction device 140, interconnected over network 150. User device 110 may represent a computing device of a user, such as a laptop computer, a tablet computer, a netbook computer, a personal computer, a desktop computer, a personal digital assistant (PDA), a smart phone, a wearable device (e.g., smart glasses, smart watches, e-textiles, AR headsets, etc.), or any programmable computer systems known in the art. In general, user device 110 can represent any programmable electronic device or combination of programmable electronic devices capable of executing machine readable program instructions and communicating with server 120, storage device 130 and other devices (not depicted) via a network, such as network 150. User device 110 can include internal and external hardware components, as depicted and described in further detail with respect to FIG. 4.

User device 110 further includes user interface 112 and application 114. User interface 112 is a program that provides an interface between a user of an end user device, such as user device 110, and a plurality of applications that reside on the device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API). In another embodiment, user utilizes interface 112 to input information such as user biometric, bank, PIN, or transaction information. In an embodiment, user device 110 is equipped with a sensor, similar to sensor 142, to detect the current biometric data from the person making the transaction request.

Application 114 can be representative of one or more applications (e.g., an application suite) that operate on user device 110. In an embodiment, application 114 is representative of one or more applications (e.g., social media applications, web conferencing applications, email applications, and banking applications) located on user device 110. In various example embodiments, application 114 can be an application that a user of user device 110 utilizes to initiate a transaction request for access to a resource. Examples of a resource may include, but are not limited to a safe deposit box, or entrance to a building, facility, floor, or event, money, and a digital asset, such as an online account, database, or document. Application 114 can be a client-side application associated with a server-side application running on server 120 (e.g., a client-side application associated with secure transaction system 101). In an embodiment, application 114 can operate to perform processing steps of secure transaction program 101 (i.e., application 114 can be representative of secure transaction system 101 operating on user device 110).

Server 120 is configured to provide resources to various computing devices, such as user device 110. In various embodiments, server 120 is a computing device that can be a standalone device, a management server, a web server, an application server, a mobile device, or any other electronic device or computing system capable of receiving, sending, and processing data. In an embodiment, server 120 represents a server computing system utilizing multiple computers as a server system, such as in a cloud computing environment. In an embodiment, server 120 represents a computing system utilizing clustered computers and components (e.g. database server computer, application server computer, web server computer, webmail server computer, media server computer, etc.) that act as a single pool of seamless resources when accessed within network computing environment 100. In general, server 120 represents any programmable electronic device or combination of programmable electronic devices capable of executing machine readable program instructions and communicating with each other, as well as with user device 110, storage device 130, transaction device 140, and other computing devices (not shown) within network computing environment 100 via a network, such as network 150.

In an embodiment, server 120 includes secure transaction program 101. In an embodiment, secure transaction program 101 may be configured to access various data sources, such as biometric database 132, transaction database 134, and account PIN database 136 that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, secure transaction program 101 enables the authorized and secure processing of personal data. In an embodiment, secure transaction program 101 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, secure transaction program 101 provides information regarding personal data and the nature (e.g., type, scope, purpose, duration, etc.) of the processing. In an embodiment, secure transaction program 101 provides a user with copies of stored personal data. In an embodiment, secure transaction program 101 allows for the correction or completion of incorrect or incomplete personal data. In an embodiment, secure transaction program 101 allows for the immediate deletion of personal data.

Server 120 may include components as depicted and described in detail with respect to cloud computing node 10, as described in reference to FIG. 5, in accordance with at least one embodiment of the present invention. Server 120 may include components, as depicted and described in detail with respect to computing device 400 of FIG. 4, in accordance with at least one embodiment of the present invention.

In various embodiments, storage device 130 is a secure data repository for persistently storing biometric data, transaction data, and account data, utilized by various applications and user devices of a user, such as user device 110. Storage device 130 may be implemented using any volatile or non-volatile storage media known in the art for storing data. For example, storage device 130 may be implemented with a tape library, optical library, one or more independent hard disk drives, multiple hard disk drives in a redundant array of independent disks (RAID), solid-state drives (SSD), random-access memory (RAM), and any possible combination thereof. Similarly, storage device 130 may be implemented with any suitable storage architecture known in the art, such as a relational database, an object-oriented database, or one or more tables.

In an embodiment, storage device 130 comprises biometric database 132, transaction database 134, and account PIN database 136. In an embodiment, biometric database 132 includes information of one or more users’ biometric data. In an embodiment, biometric data can include, but is not limited to height, weight, voice print, fingerprint, facial characteristics, iris patterns, silhouettes, finger geometry, and gait. In an embodiment, biometric database 132 includes registered biometric data of one or more authorized users associated with one or more accounts. For example, a mother wants to authorize her daughter to be an authorized user of her debit card and account. In this example, biometric database 132 includes the biometric information of both the mother and the daughter. In an embodiment, biometric database 132 includes biometric data collected from previous transactions. For example, if user A made a transaction request with their debit card in Boston, Massachusetts at 5pm for $100, and user A’s height and weight was determined to be 5′5″ and 150 lbs., respectively, at the time of the transaction request, secure transaction program 101 stores user A’s biometric data (height and weight) at the time of the transaction in biometric database 132. In an embodiment, a message is sent to the mother when her daughter attempts using the card (e.g., text, email). The message could only be informative, or it could trigger the mother’s additional authorization actions (e.g, to allow or disallow access) and to collect additional information (e.g., to specify that her daughter is the current user of the card).

In an embodiment, secure transaction program 101 receives updated biometrics from one or more users. In an embodiment, secure transaction program 101 requests a user to update their biometric information. In an embodiment, secure transaction program 101 requests a user to update their biometric information periodically. For example, secure transaction program 101 requests a user to update his/her biometric information once a year. In an embodiment, secure transaction program 101 requests a user to update his/her biometric information after denying a transaction request based, at least in part, on secure transaction program 101 determining the historical biometric data does not match the user’s current biometric data. For example, a user’s original biometric data was when they were 25 years old, and the user is now 30. The user may have grown significantly since his/her original biometric data was received by secure transaction program 101. The user attempts to make a withdrawal from an ATM but their original biometric data does not match their current biometric data and secure transaction program 101 denies the transaction. The user will receive a request from secure transaction program 101 to update their historical biometric data.

In an embodiment, transaction database 134 includes transaction data associated with a user, card, or account. In an embodiment, transaction data includes information related to transactions, including, but not limited to the time of the transaction, the amount or particular resource accessed, and the location of the transaction. For example, transaction database 134 includes information that user A made a transaction with their debit card in Boston, Massachusetts at 5pm for $100.

In an embodiment, account access credential database 136 includes account passwords related to one or more accounts or PINs associated with one or more accounts. An access credential is any user name, identification number, password, license or security token, PIN or other security code, method, technology, or device, used alone or in combination, to verify an individual’s identity and authorization to access a resource. For example, account access credential database 136 includes information that debit card number 0001 is connected to account A with PIN 1234. In an embodiment, account access credential database 136 includes information related to one or more authorized users of one or more accounts. For example, account access credential database 136 includes information that debit card number 0001 is connected to account A and users mom and daughter are authorized users for debit card number 0001 and account A.

In an embodiment, transaction device 140 includes sensor 142. In an embodiment, transaction device 140 is any device where a transaction, withdrawal, or user can gain access to a resource. In an embodiment, transaction device 140 is the device which access credentials are entered on or transmitted from. For example, transaction device 140 can include an ATM, cardless ATM, a bank, a store, a stationary terminal, a point of sale terminal, an online or mobile banking application, or a mobile device, such as user device 110. In an embodiment, a cardless ATM includes a device which provides access to a user’s account or the ability to withdraw funds or deposit funds without the need for a physical card. Instead, cardless ATM’s rely on account verification via a two factor verification system, such as a one-time password, PIN, or QR code received via a mobile banking application, text message or email of a user device, such as user device 110.

In an embodiment, secure transaction program 101 verifies the identity of a user making a transaction request at transaction device 140. In an embodiment, sensor 142 captures and/or measures biometric data of the user making the transaction request. In an embodiment, sensor 142 measures or determines one or more of the users height, weight, voiceprint, fingerprint, facial characteristics, iris pattern, silhouettes, finger geometry, and gait. In an embodiment, the type of biometric data collected from the user is dependent, at least in part, on the user, transaction type, and location of the transaction device. For example, secure transaction program 101 receives a request from a user to only measure their height and weight to verify a transaction. In another example, the transaction device is equipped with a fingerprint reader and collects the users fingerprint to verify a transaction. In yet another example, a transaction request to withdraw money from an ATM may require different biometric data than a transaction request to enter a concert. Further, a transaction request to withdraw a monetary value which exceeds a predetermined threshold may trigger matching one or more biometric data to verify the transaction. For example, a transaction request to withdraw more than $1000 from an ATM may require a matching fingerprint while a transaction request to withdraw less than $1000 from an ATM may require a matching height and weight of the user. In an embodiment, sensor 142 includes a scale, camera, scanner, imaging sensor, or any other device capable of capturing biometric data.

In an embodiment, secure transaction program 101 verifies user biometrics data in order to authorize a transaction. In an embodiment, secure transaction program 101 receives user biometric data and registers the user biometric data with a particular user and account. In an embodiment, secure transaction program 101 receives user biometric data based on user input. In an embodiment, one or more users are authorized to access an account and secure transaction program 101 receives one or more users biometric data. For example, if a husband and wife have a joint bank account and both are authorized to use the account, secure transaction program 101 registers both the husband and wife’s biometric data with respect to the particular account.

In an embodiment, secure transaction program 101 receives a transaction request to access resources. In an embodiment, the request is for a sale, monetary withdrawal, or monetary transfer. For example, secure transaction program 101 receives a request for a transaction to withdraw $100 at an ATM. In another example, secure transaction program 101 receives a request for a transaction to purchase $140 worth of goods from grocery store B. In an embodiment, secure transaction program 101 receives a request for the user to gain access to or unlock a physical location. For example, secure transaction program 101 receives a transaction request to unlock a bank box or to gain access to an event. In an embodiment, secure transaction program 101 receives a request for the user to gain access to or unlock a digital resource. For example, secure transaction program 101 receives a login request to gain access to a digital account.

In an embodiment, secure transaction program 101 determines the user’s current biometric data at the time the transaction request is received. In an embodiment, sensor 142 and transaction device 140 collect the user’s biometric data at the time the transaction request is received. For example, sensor 142 measures the user’s height and weight at the time the transaction request is received. In another example, sensor 142 collects a fingerprint from the user at the time the transaction request is received. In an embodiment, sensor 142 is located separate from transaction device 140, for example, with user device 110. For example, the user’s smartphone collects the user’s fingerprint via sensor 142 on user device 110 at the time secure transaction program 101 receives the transaction request.

In an embodiment, secure transaction program 101 trains a Generative Adversarial Network (GAN) for super-resolution data enhancement. In an embodiment, the GAN is trained to generate biometric data samples from the distribution of true parameters collected from users during previous transaction requests. In an embodiment, the GAN is trained to generate biometric data samples from the distribution of true (prior) parameters collected previously from one or more users from transaction device 140. In an embodiment, the prior parameters are associated with biometric data and the identity of one or more users. For example, the biometric data may be of a high resolution, and the identity may be associated by a classifier of the high resolution data. In an embodiment, the prior parameters are previously collected biometric data associated with one or more users. In an embodiment, the GAN is trained with one or more noisy samples of one or more measures from which the user’s identity has previously been verified. In an embodiment, a noisy sample is a sample with a variation. For example, a noisy sample may be caused by the user holding a purse or bags while on the scale causing the scale to read a heavier user weight than normal, a bias in a sensor causing a scale to read a heavier user weight than normal, the user wearing glasses causing distortion in the measure of interpupillary distance, the user wearing thicker or taller shoes such as heels, causing the users height to be detected taller than normal. In an embodiment, the trained GAN generates a distribution of possible true parameters of one or more associated identities associated with one or more noisy samples. In an embodiment, a sample of the population of known identities to secure transaction program 101 are generated and represent the posterior probability distribution of who is authenticating given the noisy data collected for one or more individuals previously.

In an embodiment, the GAN is trained based on the received historical biometric data and retrained based on biometric data for the set of users taken by a set of sensors associated with the system. For example, the GAN is trained based on other users’ historical and current biometric data. In an embodiment, the biometric data from the set of users is augmented with synthetic data for the GAN training. In an embodiment, the trained GAN is retrained by a regularized GAN ( r-GAN,), in which the r-GAN uses for its training a mathematical model of the sources of measurement noise, which is able to model the noisy measurements sampled from one or more users and their associated identities by taking the same users’ high resolution biometric data as input. After training, the r-GAN generates an estimation of a biometric and associated identity posterior distribution from the prior distribution of users’ data and associated identities, given the user’s purported identity and previously associated noisy biometric data. In an embodiment, generating the estimation of a biometric and associated identity posterior distribution is further based, at least in part, on an identified accuracy level of one or more sensors used to capture the current biometric data of the user at the time the transaction request is received.

In an embodiment, the prior probability of a user’s identity is computed relative to one or more users of secure transaction program 101 or transaction device 140. In an embodiment, secure transaction program 101 triggers additional verification if the discrimination ability is deemed poor (i.e., below a predetermined threshold) for a user among the population represented by the prior probability. For example, if the entropy of the posterior probability distribution is high (i.e., above a predetermined threshold), secure transaction program 101 requests additional verification. In an embodiment, an additional verification is any additional security step used to verify the user’s identity. For example, a PIN associated with the account or a two factor verification system.

In an embodiment, secure transaction program 101 analyzes the posterior probability distribution to determine if more than one individual is associated with a particular biometric data measurement or identity. For example, if a parent has associated a child’s parameters with an account card in addition to the parent’s. In this example, secure transaction determines 101 determines the second individual presents himself or herself for verification with the same card to be assessed and verified. Further in the example, the parent may only loan the card to the child on rare occasions. In this example, secure transaction program 101 receives a biometric data measurement that is similar to the child’s, and determines to increase the verification in order to complete the transaction request based on the low rate (i.e., below a predetermined threshold) that the child uses the card and the discriminability of the child from the rest of the population.

In an embodiment, secure transaction program 101 trains the GAN to generate posterior probability distribution based on the particular transaction device 140 or sensor 142. For example, sensor A may retrieve more accurate biometric data than sensor B. In an embodiment, a sensor which may be uncalibrated or problematic of systematic error, is automatically adjusted for. For example, if an individual user has never been verified at a given transaction device 140, the generated posterior distribution will take into account systematic biases of transaction device 140. In this example, secure transaction program 101 produces a posterior distribution from the users collected noisy samples that are coherent with the distribution of true parameters given the transaction device 140 and sensor 142.

In an embodiment, secure transaction program 101 determines if the historical biometric data input matches the user’s current biometric data at the time of the transaction request. In an embodiment, secure transaction program 101 determines the historical biometric data input matches the user’s current biometric data if the user’s current biometric data is within some tolerance, given the posterior probability distribution determined by the GAN. In an embodiment, the user’s current biometric data is within tolerance if its probability of association with the user’s identity, computed using the posterior probability distribution over the user’s historical biometric data given by the GAN, is above a threshold (e.g., 0.99). For example, if the user’s current biometric data is a height of 5′0 and weight of 105 lbs. and 5′0 and 105 lbs. has a probability of association with the user’s identity of 0.991 given the r-GAN-sampled posterior probability distribution, secure transaction program 101 determines the historical biometric data input matches the user’s current biometric data at the time of the transaction.

In an embodiment, secure transaction program 101 determines the historical biometric data input matches the user’s current biometric data if a difference between one or more historical user biometric data readings and the user’s historical user biometric data are within a predetermined range or threshold. For example, if the historical biometric data indicates the user weights 150 lbs. and at the time the transaction request is received the user weights 152 lbs., and the predetermined threshold amount is within a 3% range, secure transaction program 101 determines there is a match since the difference in the historical biometric data and the current biometric data is within a 3% difference.

In an embodiment, secure transaction program 101 authorizes the transaction request if the historical biometric data input and the user’s current biometric data match. For example, if user request to withdraw money from an ATM and their current biometric data matches the users historical biometric data input, secure transaction program 101 authorizes the ATM transaction request.

In an embodiment, secure transaction program 101 determines that a user’s historical biometric data input does not match the user’s current data. In an example, if the user requests to withdraw money from an ATM and their current biometric data does not match the user’s historical biometric data input, secure transaction program 101 requests additional verification, such as a PIN associated with the account or a two factor verification system.

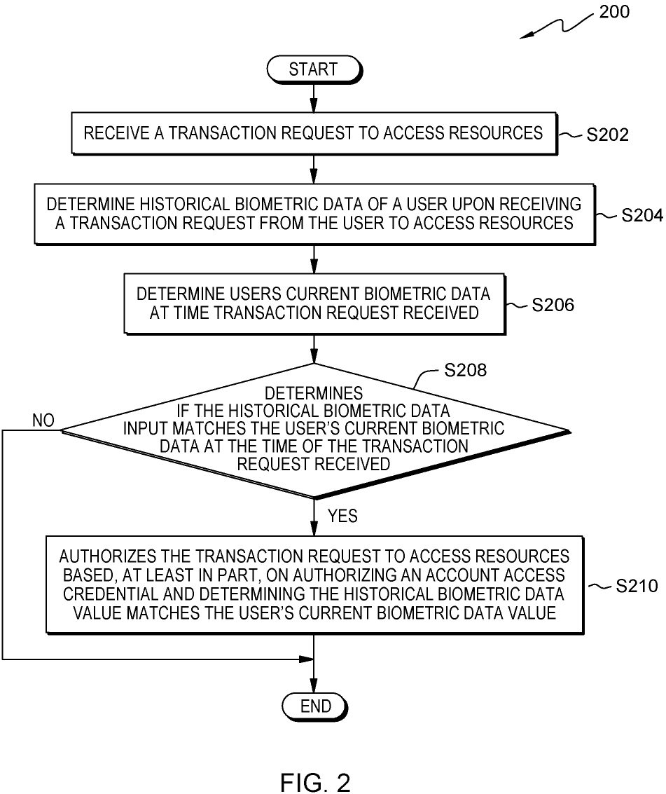

FIG. 2 is a flow chart diagram depicting operational steps for authorizing a transaction based on biometric data, generally designated 200, in accordance with at least one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

At step S202, secure transaction program 101 receives a transaction request to access resources. In an embodiment, the request may be for a sale, monetary withdrawal, monetary transfer, to access a physical area, or to access a digital resource.

At step S204, secure transaction program 101 determines historical biometric data of a user upon receiving a transaction request from the user to access resources. For example, secure transaction program 101 determines historical biometric data of the user based on accessing registered biometric data associated with the user.

At step S206, secure transaction program 101 determines the user’s current biometric data at the time the transaction request received. In an embodiment, secure transaction program 101 determines the user’s current biometric data at the time the transaction is received based on biometric data captured from one or more sensors.

At decision step S208, secure transaction programs 101 determines if the historical biometric data input matches the user’s current biometric data at the time of the transaction request received. In an embodiment, determining if the historical biometric data input matches the user’s current biometric data at the time of the transaction request is based, at least in part, on a trained GAN and a posterior probability distribution. In an embodiment, secure transaction program 101 determines the historical biometric data input matches the user’s current biometric data if the user’s current biometric data is within the posterior probability distribution of the trained GAN. In an embodiment, secure transaction program 101 determines the historical biometric data input matches the user’s current biometric data if a difference between the historical and current biometric data values are within a predetermined threshold. If the historical biometric data input matches the user’s current biometric data (decision step S208 “YES” branch), secure transaction program 101 proceeds to step S210. If the historical biometric data input does not match the user’s current biometric data (decision step S208 “NO” branch), secure transaction program 101 concludes.

At step S210, secure transaction program 101 authorizes the transaction request to access resources based, at least in part, on authorizing an account access credential and determining the historical biometric data value matches the user’s current biometric data value.

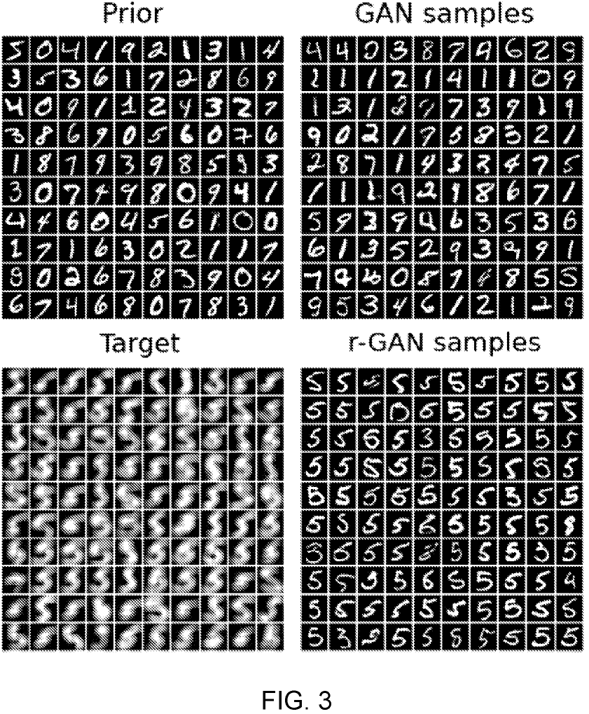

FIG. 3 is a diagram depicting a trained r-GAN for super-resolution imaging. In an embodiment, the MNIST dataset is used as a prior (Pₓ). In an embodiment and as depicted, target distribution Q_{Y} is generated by average pooling of each image with the label “5.” As depicted, target is blurred to indicate and model the noisy samples given the label. In an embodiment, a standard GAN is trained to generate the population prior, and uses weights for initialization of the r-GAN generator. After training, the r-GAN generates samples form Q_{Xg}, mostly images of “5” and occasional images close to “5” in the average pooling domain.

In an embodiment, the prior data is one or more biometric data collected from the historical biometric data from a population of users and their associated identities. In an embodiment, the target data are one or more biometric data collected from the sensors for one or more previously verified transaction requests by the user. In an embodiment, the GAN method generates samples, from the one or more distributions, such as the prior. The target is the actual data collected from the sensors during one or more verifications of the user. For example, the GAN samples from the prior data those users’ high resolution data and associated identities that are likely to have produced the noisy target data distribution for the user. Modeling noisy data from high resolution data predicts possible future biometric data for a user. For example, the noisy predicted data predicts whether the next biometric data falls within tolerance, given the posterior probability distribution sampled by the trained GAN.

FIG. 4 is a block diagram depicting components of a computing device, generally designated 400, suitable for secure transaction program 101 in accordance with at least one embodiment of the invention. Computing device 400 includes one or more processor(s) 404 (including one or more computer processors), communications fabric 402, memory 406 including, RAM 416 and cache 418, persistent storage 408, which further includes secure transaction program 101, communications unit 412, I/O interface(s) 414, display 422, and external device(s) 420. It should be appreciated that FIG. 4 provides only an illustration of one embodiment and does not imply any limitations with regard to the environments in which different embodiments may be implemented. Many modifications to the depicted environment may be made.

As depicted, computing device 400 operates over communications fabric 402, which provides communications between computer processor(s) 404, memory 406, persistent storage 408, communications unit 412, and input/output (I/O) interface(s) 414. Communications fabric 402 can be implemented with any architecture suitable for passing data or control information between processor(s) 404 (e.g., microprocessors, communications processors, and network processors), memory 406, external device(s) 420, and any other hardware components within a system. For example, communications fabric 402 can be implemented with one or more buses.

Memory 406 and persistent storage 408 are computer readable storage media. In the depicted embodiment, memory 406 includes random-access memory (RAM) 416 and cache 418. In general, memory 406 can include any suitable volatile or non-volatile one or more computer readable storage media.

Program instructions for secure transaction program 101 can be stored in persistent storage 408, or more generally, any computer readable storage media, for execution by one or more of the respective computer processor(s) 404 via one or more memories of memory 406. Persistent storage 408 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 can include one or more network interface cards. Communications unit 412 may provide communications through the use of either or both physical and wireless communications links. In the context of some embodiments of the present invention, the source of the various input data may be physically remote to computing device 400 such that the input data may be received, and the output similarly transmitted via communications unit 412.

I/O interface(s) 414 allows for input and output of data with other devices that may operate in conjunction with computing device 400. For example, I/O interface(s) 414 may provide a connection to external device(s) 420, which may be as a keyboard, keypad, a touch screen, or other suitable input devices. External device(s) 420 can also include portable computer readable storage media, for example thumb drives, portable optical or magnetic disks, and memory cards. Software and data used to practice embodiments of the present invention can be stored on such portable computer readable storage media and may be loaded onto persistent storage 408 via I/O interface(s) 414. I/O interface(s) 414 also can similarly connect to display 422. Display 422 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics Are as Follows

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models Are as Follows

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS)— the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models Are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

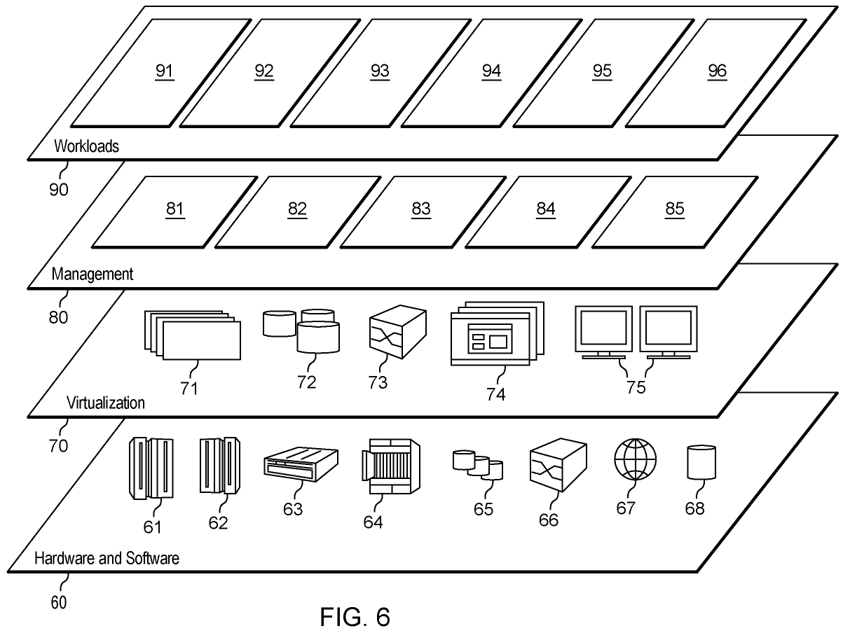

FIG. 6 is block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and biometric transaction authentication 96.

What is claimed is:

1. A computer-implemented method for transaction authorization, the computer-implemented method comprising:
receiving a transaction request from a user to access a resource;
determining historical biometric data for the user;
determining current biometric data for the user at a time the transaction request is received;
determining whether the historical biometric data for the user matches the current biometric data for the user at the time the transaction request is received; and
responsive to determining that the historical biometric data for the user matches the current biometric data for the user at the time the transaction request is received, authorizing the transaction request to access the resource.

2. The computer-implemented method of claim 1, further comprising:
generating, using a trained generative adversarial network (GAN), biometric data samples from a distribution of true parameters associated with historical biometric data of users and targets associated with historical biometric data of the user during previously verified transaction requests, and wherein:
determining that the historical biometric data for the user and the current biometric data for the user match at the time of the transaction request is received is based, at least in part, on determining with the trained GAN a posterior probability of the current biometric data for the user at the time the transaction request is received.

3. The computer-implemented method of claim 2, wherein the GAN is retrained using noisy samples of previously verified identified users generated during previous transaction requests to authorize resources.

4. The computer-implemented method of claim 3, wherein retraining the GAN using the noisy data samples further includes generating an estimation of the biometric posterior distribution.

5. The computer-implemented method of claim 4, wherein generating the estimation of the biometric posterior distribution is based, at least in part, on an identified accuracy level of one or more sensors used to capture the current biometric data of the user at the time the transaction request is received.

6. The computer-implemented method of claim 2, further comprising:
responsive to determining that an entropy of the posterior probability distribution generated by the trained GAN is below a predetermined threshold:
requesting an additional form of verification from the user; and
authorizing the transaction request to access the resource is further based on verifying the additional form of verification from the user.

7. The computer-implemented method of claim 1, wherein the historical biometric data for a user comprises at least one biometric selected from the group consisting of: height, weight, voice print, fingerprint, facial characteristic, iris pattern, silhouette, finger geometry, and gait.

8. A computer program product for transaction authorization, the computer program product comprising one or more computer readable storage media and program instructions stored on the one or more computer readable storage media, the program instructions including instructions to:
receive a transaction request from a user to access a resource;
determine historical biometric data for the user;
determine current biometric data for the user at a time the transaction request is received;
determine whether the historical biometric data for the user matches the current biometric data for the user at the time the transaction request is received; and
responsive to determining that the historical biometric data for the user matches the current biometric data for the user at the time the transaction request is received, authorize the transaction request to access the resource.

9. The computer program product of claim 8, further comprising instructions to:
generate, using a trained generative adversarial network (GAN), biometric data samples from a distribution of true parameters associated with historical biometric data of the users and targets associated with historical biometric data of the user during previously verified transaction requests, and wherein:
determining that the historical biometric data for the user and the current biometric data for the user match at the time of the transaction request is received is based, at least in part, on determining with the trained GAN the posterior probability of the current historical biometric data for the user and the current biometric data for the user at the time the transaction request is received is within a posterior probability distribution generated by the trained GAN.

10. The computer program product of claim 9, wherein the GAN is retrained using noisy samples of previously verified identified users generated during previous transaction requests to authorize resources.

11. The computer program product of claim 10, wherein the instructions to retrain the GAN using the noisy data samples further includes instructions to generate an estimation of the biometric posterior distribution.

12. The computer program product of claim 11, wherein the instructions to generate the estimation of the biometric posterior distribution is based, at least in part, on an identified accuracy level of one or more sensors used to capture the current biometric data of the user at the time the transaction request is received.

13. The computer program product of claim 9, further comprising instructions to:
responsive to determining that an entropy of the posterior probability distribution generated by the trained GAN is below a predetermined threshold:
request an additional form of verification from the user; and
authorize the transaction request to access the resource is further based on verifying the additional form of verification from the user.

14. The computer program product of claim 8, wherein the historical biometric data for a user comprises at least one biometric selected from the group consisting of: height, weight, voice print, fingerprint, facial characteristic, iris pattern, silhouette, finger geometry, and gait.

15. A computer system for transaction authorization, comprising:
one or more computer processors;
one or more computer readable storage media;
computer program instructions;
the computer program instructions being stored on the one or more computer readable storage media for execution by the one or more computer processors; and
the computer program instructions including instructions to:
receive a transaction request from a user to access a resource;
determine historical biometric data for the user;
determine current biometric data for the user at a time the transaction request is received;
determine whether the historical biometric data for the user matches the current biometric data for the user at the time the transaction request is received; and
responsive to determining that the historical biometric data for the user matches the current biometric data for the user at the time the transaction request is received, authorize the transaction request to access the resource.

16. The computer system of claim 15, further comprising instructions to:
generate, using a trained generative adversarial network (GAN), biometric data samples from a distribution of true parameters associated with historical biometric data of the users and targets associated with historical biometric data of the user during previously verified transaction requests, and wherein:
determining that the historical biometric data for the user and the current biometric data for the user match at the time of the transaction request is received is based, at least in part, on determining with the trained GAN the posterior probability of the current historical biometric data for the user and the current biometric data for the user at the time the transaction request is received is within a posterior probability distribution generated by the trained GAN.

17. The computer system of claim 16, wherein the GAN is retrained using noisy samples of previously verified identified users generated during previous transaction requests to authorize resources.

18. The computer system of claim 16, further comprising instructions to:
responsive to determining that an entropy of the posterior probability distribution generated by the trained GAN is below a predetermined threshold:
request an additional form of verification from the user; and
authorize the transaction request to access the resource is further based on verifying the additional form of verification from the user.

19. The computer system of claim 18, wherein the instructions to generate the estimation of the biometric posterior distribution is based, at least in part, on an identified accuracy level of one or more sensors used to capture the current biometric data of the user at the time the transaction request is received.

20. The computer system of claim 16, further comprising instructions to:
responsive to determining that an entropy of the posterior probability distribution generated by the trained GAN is below a predetermined threshold:
request an additional form of verification from the user; and
authorize the transaction request to access the resource is further based on verifying the additional form of verification from the user.
